(19) United States
(12) Patent Application Publication
(10) Pub. No.: US 2015/0323691 A1
(43) Pub. Date: Nov. 12, 2015

(54) METHOD FOR MONITORING AN UNDERWATER SITE

(71) Applicant: TOTAL SA, Courbevoie (FR)

(72) Inventors: Sylvie GRIMAUD, PAU Cedex (FR); Jerome ADAMY, PAU Cedex (FR)

(21) Appl. No.: 14/367,650

(22) PCT Filed: Nov. 16, 2012
(86) PCT No.: PCT/FR2012/052656

§ 371 Date: Jun. 20, 2014

(30) Foreign Application Priority Data
Dec. 20, 2011 (FR) 11 62073

(51) Int. Cl. G01V 1/38; E21B 44/00; G01V 1/28

(52) U.S. Cl. CPC G01V 1/3808; G01V 1/288; E21B 44/00

(57) ABSTRACT

The invention relates to a method for monitoring an underwater site, comprising the following steps: continuously recording at least two physico-chemical parameters around the underwater site, and activity at an industrial plant related to the underwater site.

### PRIORITY CLAIM

The present application is a National Phase entry of PCT Application No. PCT/FR2012/052656, filed Nov. 16, 2012, which claims priority from FR Patent Application No. 11 62073, filed Dec. 20, 2011, said applications being hereby incorporated by reference herein in their entirety.

### FIELD OF THE INVENTION

The present invention relates to techniques for seabed exploration or development, in particular a method for monitoring an underwater site and a device for implementing this method.

### BACKGROUND OF THE INVENTION

For many industrial activities in a marine environment, it is useful to know the characteristics of a site where an operation is planned or where industrial facilities are installed on the ocean floor.

Subsea industrial facilities can interact with their surrounding marine and subsea environment. For example, in oil and gas production activities, there may be strong interactions between the facilities and their marine and subsea environment.

For example, when drilling a well or extracting oil from a reservoir in the seabed, or when fluid is circulating in a well, there can be strong interactions with the environment around the well, potentially resulting in destabilization or modification of the geological environment. To ensure the safety of the subsea industrial facility and the stability of the geological environment around it, this geological environment should be monitored.

The existing art currently consists of characterizing the geological environment and identifying geological risks at isolated moments during measurement campaigns. These measurement campaigns are carried out before any other work is performed on site, including before the installation of the subsea facility. Other measurement campaigns may be conducted at variable time intervals while the facility is operational.

These measurement campaigns allow characterizing the geological environment and provide the status of the geological risks at various moments separated by time.

The current monitoring method has a number of disadvantages. In particular, it only provides discontinuous monitoring of the evolution of the geological environment or the geological risks over time, and therefore an isolated view at distinct moments of the safety of the subsea facility and of its effects on the geological environment around it.

There is therefore a need for a method for monitoring the characteristics of a site environment that does not have the disadvantages of current methods.

### SUMMARY OF THE INVENTION

The invention therefore proposes a method for monitoring an underwater site, comprising the steps of:

continuously monitoring at least two physico-chemical parameters around the underwater site, and

taking action on an industrial facility related to the underwater site.

Advantageously, the method according to the invention allows continuously monitoring the temporal evolution of physico-chemical parameters in real time, and therefore the stability or instability of the phenomena so characterized, for example geological phenomena.

Furthermore, the method according to the invention has the advantage of providing information continuously over time for a defined period and the correlation of several parameters characterizing the geological environment and its evolution, thereby strengthening the interpretation and evaluation of geological risks and their temporal stability for subsea facilities representing several billion euros of investment.

A method according to the invention may further comprise one or more of the following optional features, individually or in any possible combination;

the action on an industrial facility comprises the deployment of said facility at said underwater site;
when the industrial facility has been installed, the method further comprises the steps of:

continuously monitoring at least one facility parameter,

correlating the evolution of said facility parameter and said physico-chemical parameters,

taking action on the operating mode of the industrial facility;
when the industrial facility is in place, the facility parameter is selected from among the list of facility parameters comprising:

a measurement of the pressure of a fluid circulating in the facility,

the temperature at different levels in the facility,

the vibrations of the facility,

the stability of the facility;
an alert threshold is defined for at least one physico-chemical parameter, and the action on the facility depends on a comparison of the value of said physico-chemical parameter and the alert, threshold;
at least one of the physico-chemical parameters is a geological parameter of the subsoil, the parameter being measured in an area, having a radius of less than 10 km;
at least one of the physico-chemical parameters can be measured in a remote area that is more than 20 km from the facility;
at least one of the physico-chemical parameters is a geological parameter selected from among the list of geological parameters comprising:

the pressure of fluids in a geological layer,

the temperature in a geological layer,

the detection of H₂S or the measurement of the H₂S concentration in a geological layer,

the detection or the measurement of the hydrocarbon concentration in a geological layer,

the subsidence of a geological layer or of the seabed,

the deformation of a geological layer or of the seabed, and

the microseismic activity of a geological layer or geological structure;
at least one of the physico-chemical parameters is a physical parameter selected from among the list of physical parameters comprising:

the average salinity of the water at the monitored site,

the average temperature of the water at the monitored site or around the facility,

the H₂S concentration in the water at the monitored site or around the facility,

the hydrocarbon concentration in the water at the monitored site or around the facility,

the methane concentration in the water at the monitored site or around the facility,

the oxygen concentration in the water at the monitored site or around the facility,

the turbidity of the water at the monitored site or around the facility,

the direction of the ocean currents at the monitored site or around the facility, and

the speed of the ocean currents at the monitored site or around the facility.

The invention also relates to a computer program product comprising a series of instructions which, when loaded into a computer, causes said computer to execute the steps of the method according to the invention.

The invention also relates to a device for monitoring an underwater site comprising an industrial facility, said monitoring device comprising:

measurement means adapted to measure continuously and in real time at least two physico-chemical parameters around the underwater site,

at least one measurement means, for continuously measuring at least one facility parameter,

processing means, for processing correlations between the evolution of said facility parameter and said physico-chemical parameters.

### BRIEF DESCRIPTION OF THE DRAWING

The invention will be better understood by referring to the following description, given solely by way of example and with reference to the figures.

FIG. 1 which represents the steps of a method according to an embodiment of the invention.

### DETAILED DESCRIPTION OF THE FIGURE

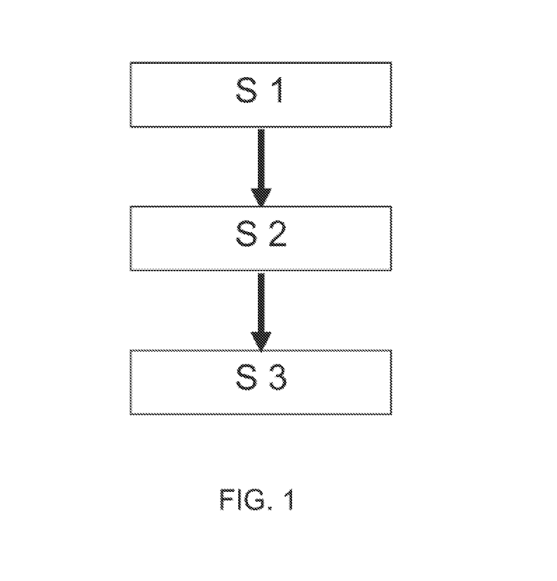

As represented in FIG. 1, according to one embodiment, the method for monitoring an underwater site according to the invention may comprise:

a measurement step S1,

a test step S2, and

an action step S3.

During the measurement step S1, at least two physico-chemical parameters around the underwater site are measured. The evolution in the values of these physico-chemical parameters is measured continuously and is sent in real time to a processing means.

The term “sent in real time” is understood to mean that the parameter values are sent to the processing means without waiting for the end of the measurement campaign. For example, the measurement means placed around the site send the parameter values to a processing means located at the surface. This information can be sent using a buoy transmission system or by messaging or acoustic transfer by ROV or cable, or by any means known to a person skilled in the art.

The physico-chemical parameters are measured around the underwater site. For example, it is possible to define different radii of investigation around a reference point at the underwater site.

It is possible to measure the parameters in a measurement area having a radius less than or equal to 2 km, or possibly less than or equal to 10 km.

In some cases it may be advantageous to measure physico-chemical parameters over a more extensive area, for example having a radius of several tens of kilometers, typically thirty kilometers.

Among the physico-chemical parameters that can be measured around the underwater site it is possible to measure geological parameters of the underwater site, for example geological parameters of the subsoil of the underwater site.

The monitored geological parameters may include one or more of the following, individually or in any possible combination:

the pressure of fluids in a geological layer,

the temperature in a geological layer,

the detection of H₂S or the measurement of the H₂S concentration in a geological layer,

the detection or the measurement of the concentration of hydrocarbons in a geological layer,

the subsidence of a geological layer or of the seabed,

the deformation of a geological layer or of the seabed, and

the microseismic activity of a geological layer or geological structure.

A geological layer corresponds to internally consistent sedimentary rock or soil between two approximately parallel surfaces. These surfaces correspond to discontinuities, rapid petrophysical variations that define a set of adjacent layers.

Of the physico-chemical parameters that can be measured around the underwater site, it is possible to measure physical parameters, for example such as the physical parameters of the water column around the underwater site.

The monitored physical parameters may include one or more of the following, individually or in any possible combination:

the average salinity of the water at the monitored site,

the average temperature of the water at the monitored site.

the H₂S concentration in the water at the monitored site,

the hydrocarbon concentration in the water at the monitored site,

the methane concentration in the water at the monitored site,

the oxygen concentration in the water at the monitored site,

the turbidity of the water at the monitored site,

the direction of the ocean currents at the monitored site, and

the speed of the ocean currents at the monitored site.

During the test step S2, the values of the physico-chemical parameters are analyzed continuously and in real time so as to determine whether action needs to be taken on the industrial facility.

According to one embodiment, it is possible to define an alert threshold for each measured physico-chemical parameter. During the test step, it is therefore determined whether the measured parameter values exceed their respective threshold values.

Depending on the parameter values tested during the test step, the parameters continue to be measured without taking any action on the facility, or action is taken on the facility while continuing to measure the physico-chemical parameters around the site.

During the action step, action is taken on the industrial facility.

According to one embodiment, the action on the facility may include the installation of the facility.

For example, the site does not contain an industrial facility and during the test step, it is decided whether or not to deploy an industrial facility on the site, based on the measured values of the physico-chemical parameters.

The underwater site may already contain certain industrial facilities and the test step allows validating the deployment of new industrial facilities at the underwater site.

In another embodiment, the action on the facility may include an action on the operation of a facility already installed at the underwater site.

A method according to this embodiment may further comprise:

a step of monitoring at least one parameter of the facility, and

a correlation step.

During the step of monitoring a parameter of the system, at least one parameter of the industrial facility deployed at the underwater site is monitored continuously and in real time.

The parameters of the industrial facility that, may be monitored include:

the temperature at different levels in the facility,

the vibrations of the facility,

the stability of the facility, or measurement of the pressure of a fluid circulating in the facility.

During the correlation step, it is possible to correlate the variations in the physico-chemical parameters measured around the site, with parameters of the facility.

Advantageously, the correlation of the variations in the physico-chemical parameters with those in the parameters of the industrial facility allows measuring the evolution in the physico-chemical parameters of the underwater site in order to deduce a possible evolution of the facility parameters.

Thus, by knowing the tolerances for the parameters of the industrial facility, it is possible to derive tolerance thresholds for the physico-chemical parameters of the site.

It is therefore possible, by monitoring the evolution of physico-chemical parameters of the underwater site, to decide to modify the operating mode of the plant where necessary or even to shut it down temporarily or permanently.

According to one embodiment of the invention, it is possible in the case of oil production to correlate the fluid pressure in the superficial layers and the number of microseismic events with the pressure in the reservoir.

For example, if a fluid pressure observed in the superficial layers exceeds a predefined threshold, coupled with an abnormal increase in the number of microseismic events, this is then correlated with an observed pressure in the reservoir and action is taken on the reservoir pressure.

According to one embodiment of the invention, it is possible in the case of oil production to correlate the gas release rate at the seabed and the gas concentration in the water with the physical parameters of the reservoir.

For example, if an increase is observed in the gas release rate at the seabed, coupled with a variation in the gas concentration in the water, then action is taken on the physical parameters of the reservoir.

According to one embodiment of the invention, it is possible to correlate the seismic activity around the site with the operating mode of the facility.

For example, if a pronounced increase in microseismic events and movement on the tiltmeter are observed, action is taken on the facility in order to achieve safe conditions.

According to one embodiment of the invention, multiple physico-chemical parameters that can be correlated with facility parameters can be monitored. Advantageously, this provides information redundancy, reducing the risk of misinterpreting an evolution in the parameters.

Modifications to the operating mode of underwater facilities are complex and very expensive to implement. It is important to be able to reduce the risk of misinterpreting an evolution in the physico-chemical parameters.

The invention also relates to a device for monitoring an underwater site, which allows implementing the method of the invention.

According to one embodiment of the invention, the monitoring device may include measurement and processing means.

The measurement means are configured to measure continuously and in real time at least two physico-chemical parameters around the underwater site. A person skilled in the art knows how to select the at least one suitable measurement means, according to the physical-chemical parameters to be measured.

The processing means, for example a processor or computer, is configured to allow the continuous monitoring in real time of measurements of physico-chemical parameters of the underwater site.

According to one embodiment, the device according to the invention also comprises measurement means for continuously measuring parameters of the industrial facility.

The device according to the invention may also comprise correlation means for correlating the evolution of the facility parameters and the physico-chemical parameters of the underwater site.

The invention is not limited to the embodiments described and shall be interpreted in a non-limiting manner, encompassing all equivalent embodiments.

1. A method for monitoring an underwater site, comprising:
continuously monitoring at least two physico-chemical parameters around the underwater site, and
taking action on an industrial facility related to the underwater site.

2. The method of claim 1, wherein the action on the industrial facility comprises deploying said industrial facility at said underwater site.

3. The method of claim 2, wherein the industrial facility has been deployed, said method further comprising the steps of:
continuously monitoring at least one facility parameter,
correlating an evolution of said facility parameter and said physico-chemical parameters,
taking action on an operating mode of the industrial facility.

4. The method of claim 3, wherein the facility parameter is selected from the list of facility parameters comprising:
a measurement of the pressure of a fluid circulating in the facility,
a temperature at different levels in the facility,
a vibrations of the facility,
a stability of the facility.

5. The method of claim 1, wherein an alert threshold is defined for at least one physico-chemical parameter, and the action on the facility depends on a comparison of the value of said physico-chemical parameter and the alert threshold.

6. The method of claim 1, wherein at least one of the physico-chemical parameters is a geological parameter of the subsoil, the parameter being measured in a measurement area having a radius of less than 10 km.

7. The method of claim 1, wherein at least one of the physico-chemical parameters is a geological parameter of the subsoil, the parameter being measured in a remote measurement area that is more than 20 km from the facility.

8. The method of claim 1, wherein at least one of the physico-chemical parameters is a geological parameter selected from the list of geological parameters comprising:
a pressure of fluids in a geological layer,
a temperature in a geological layer,
a detection of H₂S or the measurement of the H₂S concentration in a geological layer,
a detection or the measurement of the hydrocarbon concentration in a geological layer,
a subsidence of a geological layer or of the seabed,
a deformation of a geological layer or of the seabed, and
a microseismic activity of a geological layer or geological structure.

9. The method of claim 1, wherein at least one of the physico-chemical parameters is a physical parameter selected from the list of physical parameters comprising:
an average salinity of the water in the measurement area around the underwater site,
an average temperature of the water in the measurement area around the underwater site or around the facility,
a H₂S concentration in the water in the measurement area around the underwater site or around the facility,
a hydrocarbon concentration in die water in the measurement area around the underwater site or around the facility,
a methane concentration in the water in the measurement area around the underwater site or around the facility,
a oxygen concentration in the water in the measurement area around the underwater site or around the facility,
a turbidity of the water in the measurement area around the underwater site or around the facility.
a direction of the ocean currents in the measurement area around the underwater site or around the facility, and
a speed of the ocean currents in the measurement area around the underwater site or around the facility.

10. (canceled)

11. A system for monitoring an underwater site comprising an industrial facility, the monitoring device comprising:
measurement means adapted to measure continuously and in real time at least two physico-chemical parameters around the underwater site,
at least one measurement means, for continuously measuring at least one facility parameter, and
processing means, for processing correlations between the evolution of said facility parameter and said physico-chemical parameters.
